(19) United States
(12) Patent Application Publication
(10) Pub. No.: US 2016/0300647 A1
(43) Pub. Date: Oct. 13, 2016

(54) METALLIC MAGNETIC MATERIAL WITH CONTROLLED CURIE TEMPERATURE AND PROCESSES FOR PREPARING THE SAME

(71) Applicant: INSTITUTUL NATIONAL DE CERCETARE DEZVOLTARE PENTRU FIZICA TEHNICA IASI, Iasi (RO)

(72) Inventors: Horia CHIRIAC, Str. Alexandru Vlahuta nr. 47 (RO); Nicoleta LUPU, Sos. Nationalã nr. (RO)

(73) Assignee: INSTITUTUL NATIONAL DE CERCETARE -DEZVOLTARE PENTRU FIZICA TEHNICA ISAI, Isai (RO)

(21) Appl. No.: 15/101,397

(22) PCT Filed: Dec. 3, 2014
(86) PCT No.: PCT/RO2014/000032

§ 371 Date: Jun. 2, 2016

(30) Foreign Application Priority Data
Dec. 3, 2013 (RO) A 2013 00949

(51) Int. Cl. H01F 1/03

(52) U.S. Cl. CPC H01F 1/0306; C22C 38/14

(57) ABSTRACT

The invention relates to a metallic magnetic material with biocompatible elements (Ti, Ta or Mn), with glassy quasi-amorphous structure and controlled Curie temperature, and the processes for preparing the same. The hereby material has its composition expressed in atomic percent: Fe=59 . . . 67%, Nb=0.1 . . . 1%, B=20%, biocompatible material (Ti, Ta or Mn)=12 . . . 20%), Curie temperature within the interval 0 . . . 70° C., saturation magnetic induction of 0.05 . . . 1.1 T and strong magnetic response when introduced in a high frequency magnetic field. The processes used to obtain this material directly under the form of ribbons, glass-coated micro/nanowires or nano/micropowders consist in rapid quenching of the mixtures with previously mentioned compositions under extremely rigorous controlled conditions, in high vacuum of minimum 10^{<}mbars or in controlled helium or argon atmosphere in order to avoid oxidation.

### DESCRIPTION OF THE INVENTION

The invention relates to a Fe—Nb—B-type metallic magnetic material with addition of biocompatible material (Ti, Ta or Mn) with “glassy” quasi-amorphous structure and controlled Curie temperature, with applications in the realization of (bio)medical sensors, and especially in inducing controlled hyperthermia, and to processes for preparing the same in various uni- or bi-dimensional shapes.

It is well-known that the ferromagnetic materials have specific magnetic properties at temperatures smaller that the transition temperature called “Curie temperature”. These specific magnetic properties disappear at temperatures above Curie temperature, denoted by T_{C}. The temperature of the transition from the ferromagnetic state (magnetic order) to paramagnetic state (magnetic disorder) is an intrinsic parameter of the material, which depends on its composition and preparation process, as well as on the subsequent thermal treatments applied to the corresponding material.

It is known that the Curie temperature of the transition metals Fe, Co and Ni is much higher than the environmental temperature (T_{C,Fe}=770° C.; T_{C,Co}=1100° C.; T_{C,Ni}=358° C.). It is also known that the alloys which contain Fe, Co and/or Ni have the temperature of transition from the ferromagnetic to the paramagnetic state within a wide range of values (from negative values to over 1000° C.), depending on their composition, thermal history and crystalline structure [1].

It is known that the Curie temperature of the transition metal-metalloid (MT-M, where MT=Fe, Co, Ni, and M=B, P, C, Si, Al) amorphous alloys, obtained by rapid quenching from the melt as ribbons, conventional wires or thin layers is always smaller than the Curie temperature of the pure transition metals, yet the values are high enough as compared to the ambient temperature, as they range between 120 . . . 600° C. [2]. It is also known that the glass-coated amorphous microwires which contain Fe and/or Co, obtained through rapid solidification processes with metallic core diameters of 1 . . . 30 μm, have Curie temperatures of 300 . . . 400° C. [3]. The addition of Cr to the composition of the Co—Fe—Si—B glass-coated microwires results in a decrease of the Curie temperature by up to 75° C. [4].

These amorphous materials, irrespective of their shape and the fabrication method, have the disadvantage that they have high T_{C} values and cannot be used in applications which require transition temperatures ranging between 20 and 50° C., as for instance in magnetic hyperthermia or for certain sensors used in connection with the systems for human body temperature evaluation.

Reference [5] describes a materials based on Ni—Cu with T_{C}=43° C. and obtained as nanopowder through a very complex chemical process. Even if this material seems to have a T_{C} adequate at least for use in hyperthermia, it still has some shortcomings:
its Curie temperature cannot be varied depending on the final application;
it can only be obtained as nanopowder through a very complex chemical process;
the nanopowders exhibit a superparamagnetic behavior and their magnetization is small, of only 2.5 emu/g, which makes difficult their heating in alternative current, as is the case of magnetic hyperthermia;
it contains Ni, which can induce allergies and generate biocompatibility problems.

There have also been attempts to use the Ni nanowires in the hyperthermia process, as presented in reference [6]. Even if it was established that the radiofrequency heating of the Ni nanowires placed in contact with cancer cells produced their death, this material has certain major shortcomings:
the Curie temperature of Ni being of about 360° C., one can not rigorously control the temperature of the body subjected to magnetic hyperthermia;
Ni can induce allergies and generate biocompatibility problems.

Reference [7] presents data about ribbons with thickness of 20 . . . 40μm and glass-coated microwires with the metallic core diameter of 6.5 . . . 26 μm and glass coat thickness under 20 μm, obtained through rapid quenching from the melt, with nominal composition Fe_{67.7}Nb_{0.3}Cr₁₂B₂₀, presenting a quasi-amorphous structure which permits to obtain low magnetic transition temperatures, within the interval 35 . . . 45° C., depending on the sample shape. This material is useful for some applications, hyperthermia included. Its main shortcoming consists in its Cr content that can generate some biocompatibility problems and therefore restricts the medical applications which imply direct contact with the cells.

The technical problem, which the invention can solve, consists in producing a metallic magnetic material of Fe—Nb—B type with addition of biocompatible elements (Ti, Ta or Mn), with glassy quasi-amorphous structure and controlled Curie temperature, for applications in (bio)medical sensors and hyperthermia, and in the realization of certain processes for preparing the same in various uni- and two-dimensional shapes.

The hereby Fe—Nb—B-type metallic magnetic material with biocompatible elements solves this technical problem and removes the shortcomings of other known materials presented above, given that:
1. it has the composition with the following atomic concentrations Fe=59 . . . 67%; Nb=0.1 . . . 1%, B=20%, biocompatible material (Ti, Ta or Mn)=12 . . . 20%;
2. it is characterized by a glassy quasi-amorphous structure, which confers special magnetic characteristics, inclusively Curie temperatures ranging between 0 and 70° C.;
3. the biocompatible elements (Ti, Ta or Mn) which it contains provide its biocompatibility and the possibility to be used in medical applications, inclusively those which imply direct contact with the cells;
4. it has high magnetic permeability and susceptibility near the magnetic transition temperature (T_{C}), which makes it useful for sensors based on the magnetic permeability variation, as well as in hyperthermia applications;
5. it can be obtained directly as ribbons, glass-coated micro/nanowires or nano/micropowders;
6. the magnetic transition temperature (T_{C}) can be accurately modified by choosing the Ti, Ta or Mn content in the material accordingly;
7. it has a magnetic saturation induction of 0.05 . . . 1.1 T, depending on Ti, Ta or Mn content, which determines a strong magnetic response when introduced in a high frequency alternative magnetic field.

Procedure 1 to produce the Fe—Ni—B metallic magnetic material with biocompatible elements, shaped as magnetic ribbons, through rapid quenching from the melt according to the invention, consists in that the metallic mix: Fe=59 . . . 67 at. %, Nb=0.1 . . . 1 at. %, B=20 at. %, and biocompatible material (Ti, Ta or Mn)=12 . . . 20 at. % is melt in a quartz tube, closed at the bottom, placed in a vacuum chamber, after which pieces of the alloy weighing 3 . . . 4 g each are extracted from the melted alloy by means of a special system consisting of several quartz tubes, in order to provide a good homogeneity of the alloy and the adequate shape such that to be taken up in the amorphizing crucible consisting of a quartz tube ended with a boron nitride part presenting at its end a rectangular nozzle with the width of 0.5 . . . 0.8 mm and the length of 1 . . . 3 mm, depending on the dimensions of the ribbon to be realized. The crucible is placed in front of a copper disk with the diameter of 35 cm, rotating with a peripheral speed of 30 . . . 35 m/s, at a distance of 0.5 mm, to provide a uniform flow of the molten alloy. The crucible is introduced in an induction coil consisting of 5 turns of copper pipe, supplied by a medium frequency power generator, which ensures the melting of the alloy pieces previously extracted from the melted alloy. When the melted alloy is heated up to 1000 . . . 1400° C., at the upper part of the crucible an overpressure of argon gas of 0.15 . . . 0.22 bars is applied, which forces the liquid alloy to be ejected on the rotating disk, resulting in the formation of a metallic ribbon with the thickness ranging between 10 and 40 μm and width of 0.2 . . . 5 mm. In order to avoid the oxidation of the melted alloy, the copper disk—crucible system is placed in a high vacuum stainless steel chamber (minimum 10⁴ mbar), after which argon or helium is introduced, the amorphous ribbon being obtained in a controlled atmosphere.

Procedure 2 to obtain the metallic magnetic material of Fe—Nb—B type with biocompatible elements shaped as glass-coated micro/nanowires through rapid quenching from the melt, according to the invention, consists in the fact that the alloy pieces weighing 3 . . . 4 g, extracted from the alloy according to the technique previously described in Procedure 1, is introduced in a Duran glass tube with the diameter of 12 mm and glass wall thickness of 1 mm, closed at the bottom and connected to a vacuum system at its upper part, placed in the centre of the induction coil supplied by a medium frequency power generator. The alloy heated to melting results in glass softening and is subsequently drawn at a controlled speed of 2500 . . . 3000 m/min on the collecting bobbin, resulting in the formation of a glass coated metallic wire with metallic core diameter of 80 . . . 950 nm and glass coating thickness of 5 . . . 6.5 μm. In order to obtain the glass coated micro/nanowires it is necessary to provide a vacuum level of 60 . . .70 mm H₂O.

Procedure 3 to obtain the hereby metallic magnetic material of Fe—Nb—B type with biocompatible elements under the form of micro/nanopowders consists in mechanically milling the ribbons obtained through rapid quenching from the melt on a rotating metallic disk according to Procedure 1. The Fe—Ni—B ribbons with bio-compatible elements are subjected to preliminary thermal treatments in vacuum of 10⁻⁵ mbar and temperatures of 300 . . . 400° C., to diminish their hardness. The resulted ribbons are then cut in pieces of 3 . . . 5 mm and introduced in two milling vials of a planetary ball mill together with the milling balls in a ratio ball mass:milling material mass=50:1. In order to avoid powder contamination with other chemical elements, it is necessary that both the milling vials and the balls are made of hardened stainless steel. The ribbons are milled in a liquid medium in which the oleic acid and heptane represent 15 . . . 25 vol. % and 2 . . . 5 vol. %, respectively, of the amount of milled material, at a milling speed of 350 rpm with two-way rotation for 1 . . . 120 hours, the obtained powders having the sizes between 5 nm and 80 . . . 100 μm, depending on the milling time. The powders obtained in this way are washed at least five times in an ultrasound heptane bath, each washing lasting at least 5 min., to remove any trace of oleic acid. For their use in magnetic hyperthermia, the powders are additionally washed 5 times for 5 minutes in a solution of NaOH 10%, in an ultrasound bath. The resulted powders are dried in a vacuum oven for 2 hours at the temperature of 70° C.

Procedure 4 to obtain the hereby metallic magnetic material of Fe—Nb—B type with biocompatible elements shaped as nanopowders through arc discharge in inert gas atmosphere, consists in introducing a piece of alloy weighing 3 . . . 4 g, of the basic alloy according to the previously described Procedure 1, in a wolfram crucible, which represents one of the electrodes of the arc discharge, situated 4 . . . 5 mm apart from the second electrode, consisting of a wolfram rod. The whole system is placed in a sealed double-walled stainless steel chamber cooled with a liquid at the temperature of −10 . . . −15° C. After producing a vacuum of 2×10⁻⁴ mbars in the chamber, 99.999% pure helium is introduced at a depression value of −0.2 . . . −0.95 bars compared to the atmospheric pressure. By applying a high frequency potential difference, the d.c. electric arc plasma is initiated between the two electrodes, with I_{discharge}=40 . . . 200 A, at a potential difference U_{discharge}=20 . . . 40 V, which determines the melting of the metal and then its conversion in vapors. The nanoparticles generated thereby are gathered after passivation in argon atmosphere in order to avoid its fast oxidation at the contact with the environment. By modifying the inert gas pressure during the discharge, the distance between electrodes and the discharge voltage within the described intervals, nanoparticles with dimensions ranging between 5 and 100 nm are obtained.

By applying the invention the following advantages can be obtained:
obtain a metallic magnetic material with biocompatible elements and glassy quasi-amorphous structure, with the magnetic transition temperature (T_{C}) ranging between 0 . . . 70° C., depending on the concentration of the biocompatible element and the applications in which it is to be used;
obtain a metallic magnetic material with biocompatible elements in various uni-dimensional (nanopowders, nanowires) and bidimensional (ribbons, microwires, micropowders) forms directly through the rapid quenching method, with high saturation magnetization, which has as result a fast, extremely rigorously controlled heating in the presence of a high frequency alternative magnetic field;
improve the reproducibility and thermal stability of the metallic magnetic material with biocompatible elements and with T_{C} within the interval 0 . . . 70° C. for utilization in medical applications, for instance in hyperthermia, namely allowing the local heating of a malign tumor when applying a high frequency alternative magnetic field at an optimum temperature value, namely the magnetic transition temperature, irrespective of the intensity of the applied magnetic field, ensuring a self-regulation of the desired temperature, which is not possible in the case of other magnetic materials;
obtain a metallic magnetic material with biocompatible elements and controlled Curie temperature which, by its composition, shape, dimensions and specific magnetic characteristics, can be used to produce magnetic field sensors and to detect other mechanical parameters which depend on the magnetic field value, which can be blocked in operation at a certain environmental temperature.

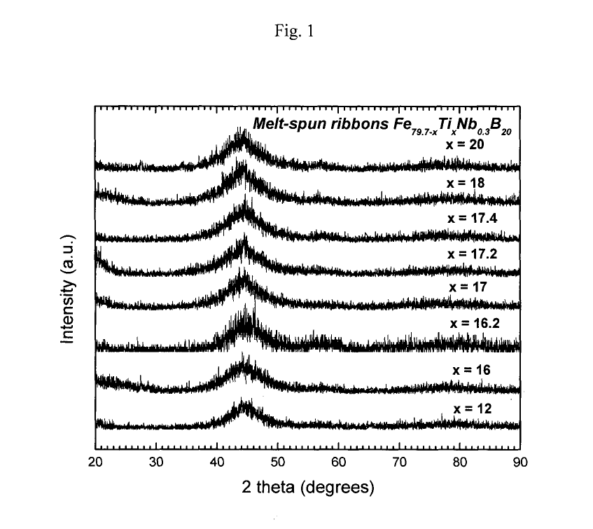

Three examples are given in the following related to FIGS. 1 . . . 7, which represent:

FIG. 1, X-ray diffraction patterns obtained for as-quenched ribbons with nominal compositions Fe_{79.9-x}TiₓNb_{0.3}B₂₀, where x=12 . . . 20 at. %;

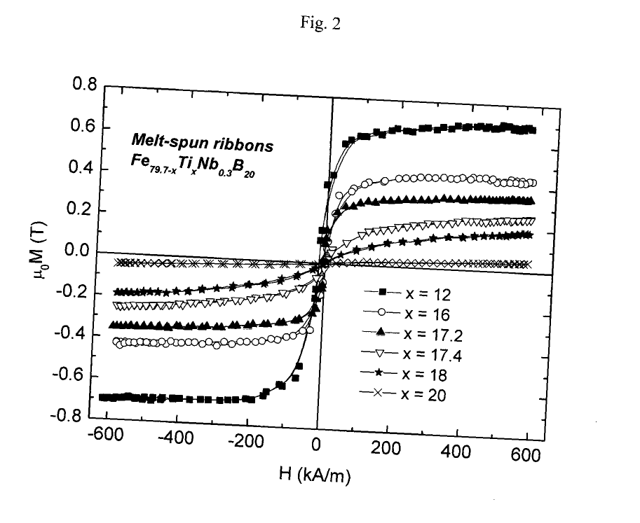

FIG. 2, Magnetic hysteresis loops for as-quenched ribbons with nominal compositions Fe_{79.7-x}TiₓNb_{0.3}B₂₀, where x=12 . . . 20 at. %;

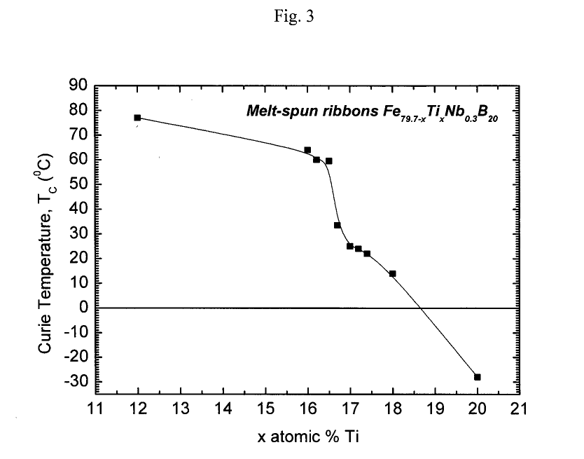

FIG. 3, Curie temperature variation vs. Ti content for as-quenched ribbons with nominal composition Fe_{79.7-x}TiₓNb_{0.3}B₂₀, where x=12 . . . 20 at. %;

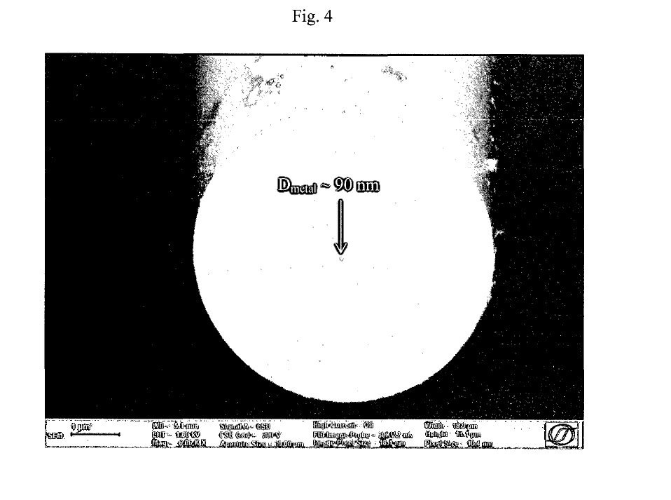

FIG. 4, SEM images of a glass-coated wire with the inner metallic diameter of 90 nm and glass coating thickness of 5.5 μm, with nominal composition Fe_{64.7-x}Mn₁₅Nb_{0.3}B₂₀;

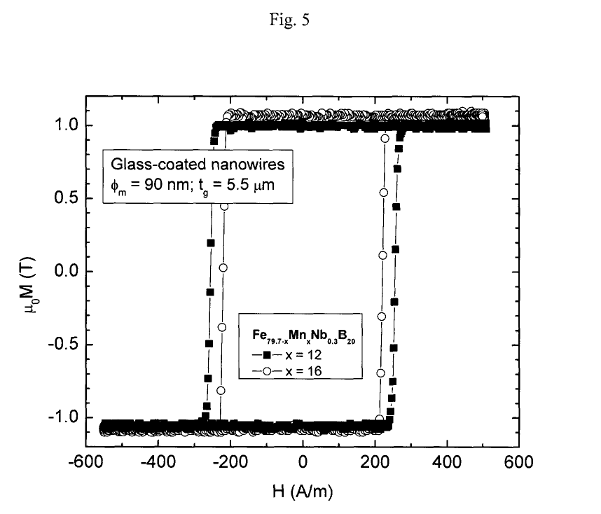

FIG. 5, Magnetic hysteresis loops for as-quenched glass-coated nanowires with nominal compositions Fe_{79.7-x}MnₓNb_{0.3}B₂₀, where x=12 and 16 at. %, with the inner metallic diameter of 90 nm and glass coating thickness t_{g}=5.5 μm;

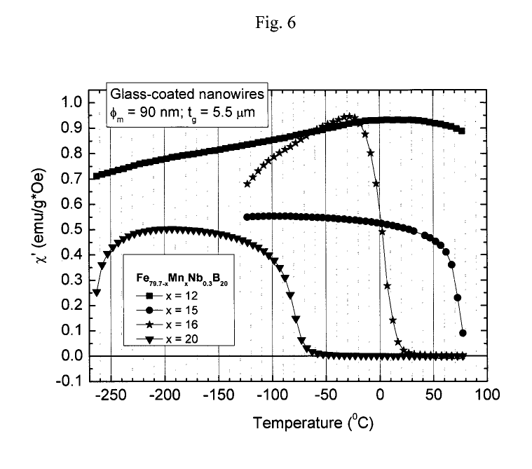

FIG. 6, Variation of the real part of the magnetic susceptibility with temperature for as-quenched glass coated nanowires with nominal compositions Fe_{79.7-x}MnₓNb_{0.3}B₂₀, where x=12 . . . 20 at. %, with the inner metallic diameter Φₘ=90 nm and glass coating thickness t_{g}=5.5 μm;

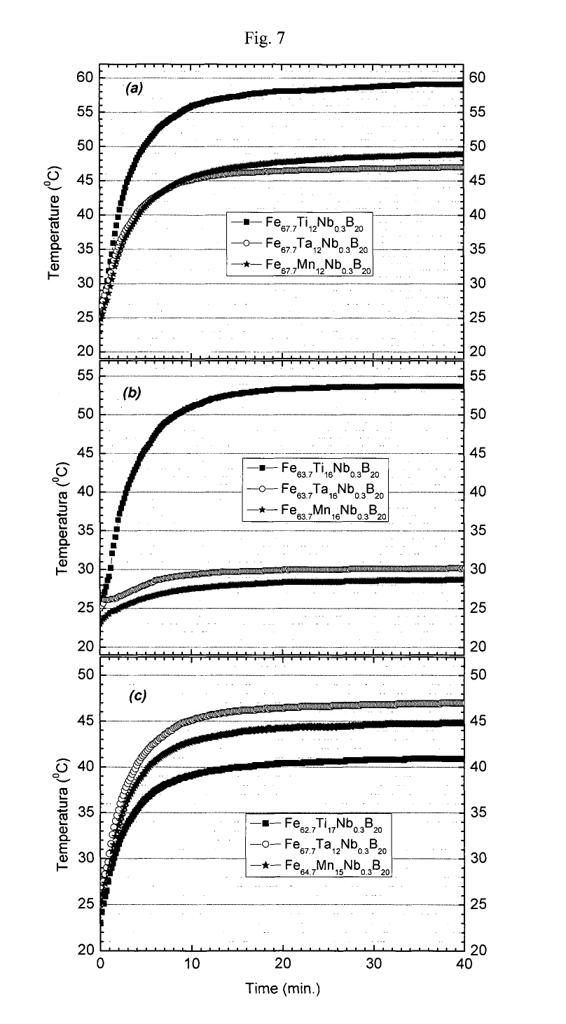

FIG. 7, Equilibrium temperature vs. time for nanopowders of Fe_{79.7-x}TiₓNb_{0.3}B₂₀, Fe_{79.7-x}TaₓNb_{0.3}B₂₀ and Fe_{79.7-x}MnₓNb_{0.3}B₂₀ respectively, where x=12 . . . 17 at. %, with sizes between 20 . . .100 nm, obtained by milling ribbons with the same composition in oleic acid, in an alternative magnetic field, H=350 mT, and the frequency, f=153 kHz.

### EXAMPLE 1

Procedure hereby consists in the preparation of an alloy of pure components, with nominal composition Fe_{79.7-x}TiₓNb_{0.3}B₂₀, by inductive melting in a quartz tube sealed at the bottom, placed in a vacuum chamber. From the molten alloy one then extract, by means of a special system consisting of several quartz tubes, pieces of alloy of 3 . . . 4 g each to provide a good homogeneity of the alloy and an adequate shape for its subsequent use for producing metallic ribbons by rapid quenching from the melt. The alloy piece of 3 . . . 4 g is then introduced in a quartz tube ended at its bottom with a boron nitride part, which has at its end a rectangular nozzle with the length of 0.5 mm and width of 3 mm. This crucible is placed in front of a copper disc with the diameter of 36 cm, rotating with a peripheral speed of 30 m/s, at a distance of 0.5 mm, in order to provide a uniform flow of the molten alloy. The crucible is introduced in an induction coil consisting of 5 turns of copper pipe, supplied by a medium frequency power generator, which provides re-melting of the piece of alloy previously extracted from the molten alloy. When the alloy is melted and heated at 1200±50° C., an overpressure of argon gas of 0.15 bar is introduced at the upper part of the crucible, which forces the liquid alloy to be ejected on the rotating disc, thus resulting in the formation of a metallic melt-spun ribbon with the thickness of 15 . . . 20 μm and widths of 0.4 . . . 0.5 mm. In order to avoid the oxidation of the molten alloy, the copper disc—crucible system is placed inside a vacuum chamber (at least 10⁻⁴ mbar), after which argon or helium is introduced, the ribbon being obtained in a controlled atmosphere.

The melt-spun ribbons obtained hereby present a quasi-amorphous structure, as in FIG. 1, consisting in atoms agglomerations (clusters) with the size of 2 . . . 6 nm, specific to the “glassy metals” materials, irrespective of the Ti content. This specific microstructure confers the Fe—Nb—B metallic material a ferromagnetic behavior with the following characteristics:
saturation magnetic induction, μₒMₛ of 0.05 . . . 0.07 T, depending on the Ti content, as in FIG. 2;
coercive field H_{c} of 100 . . . 300 Oe, depending on Ti content, as in FIG. 2;
Curie temperature, T_{C} of −30 . . . 78° C., depending on Ti content, as in FIG. 3.

The Curie temperature T_{C} of 20 . . . 70° C. of interest for the Fe—Nb—Ti—B ribbons, according to the invention, are obtained for concentrations of Ti from 18 to 16 at. %, as in FIG. 3, for which the values of the saturation magnetic induction also range between 0.2 and 0.45 T, according to magnetic hysteresis loops from FIG. 2. These ribbons with “glassy”-type quasi-amorphous structure can be used directly in magnetic field sensors to determine other physical parameters which depend on the magnetic field, sensors whose operation is blocked at a certain temperature, according to the invention.

### EXAMPLE 2

The process hereby consists in the preparation of glass-coated nano/microwires with nominal composition Fe_{79.7-x}MnₓNb_{0.3}B₂₀, where x=12 . . . 20 at. %. The basic alloy is prepared from pure elements through magnetic induction in a quartz tube sealed at the bottom, placed inside a vacuum chamber. Pieces of 3÷4 g are extracted from this alloy according to the description from Example 1, then introduced in a Duran glass pipe with the diameter of 12 mm and wall thickness of 1 mm, sealed at its bottom and connected at its upper part to a vacuum system, placed inside an induction coil supplied by a medium frequency power generator. The alloy inductively heated up to the melting temperature Tₘₑₗₜ=1100° C.±50° C. produces glass softening and is initially drawn manually to initiate the process, and then automatically with a controlled speed of 3000±150 m/min., on a collecting bobbin located in air, thus resulting a glass-coated metallic wire with the metallic inner diameter of about 90 nm and glass coating thickness of 5.5 μm, as in FIG. 4. In order to avoid the oxidation of the melted alloy and to draw the metallic wire into the glass, a vacuum of 60 . . . 70 mm H₂O in ensured.

The glass coated nanowires with nominal composition Fe_{79.7-x}MnₓNb_{0.3}B₂₀, where x=12 . . . 20 at. %, obtained hereby, preserve the quasi-amorphous structure as in the case of ribbons presented in the Example 1; they present a magnetic saturation induction of 1 . . . 1.1 T depending on the Mn content, as in FIG. 5, and relative magnetic permeability of 3500 . . . 4000. Their magnetic transition temperature T_{C} significantly changes with the Mn content for the glass-coated nanowires, from −70° C. to over 70° C., as in FIG. 6, thus covering the temperature interval of 20 . . . 70° C., according to the invention. These glass-coated nanowires hereby can be used in the realization of magnetic field sensors within a well-established operation range, such as the sensors which can get blocked at temperatures lower or equal with the transition temperature, T_{C}. This kind of nanowires can be also used in the process of cancer cell destruction through hyperthermia, by automatically maintaining the temperature at a value equal to T_{C} .

### EXAMPLE 3

Process hereby consists in obtaining a metallic magnetic material of Fe—Nb—B type with biocompatible (Ti, Ta, Mn) elements under the form of micro/nanopowders through milling in a liquid medium, from the ribbons obtained through rapid quenching from the melt as in Example 1. The obtained powders must preserve the quasi-amorphous structure existing in the obtained ribbons as in Example 1, in order to have the magnetic transition temperature (T_{C}) within the interval 20 . . . 70° C., according to the invention. That is why the milling process that implies dissipation of energies and local high temperatures induced by the friction process must be controlled very strictly. According to the invention, the Fe—Nb—B ribbons with biocompatible elements (Ti, Ta, Mn) are subjected to a preliminary thermal treatment at a temperature of 400° C., in a vacuum of 10⁻⁵ mbar, in order to diminish the hardness and to increase the brittleness. The annealed ribbons are cut in pieces of 3-5 mm and introduced in two vials of hardened stainless steel, together with the balls made of the same material at a mass ratio balls: milling material=50:1, oleic acid 18 vol. % and heptane 2.7 vol. %. The two planetary two-ways ball mills are rotating with a speed of 550 rpm. The Fe_{79.7-x}TiₓNb_{0.3}B₂₀ powders (where x=12 . . . 20 at. %), with average size of 20 . . . 60 nm, are obtained by milling the ribbons for 3 hours, while for the powders of Fe_{79.7-x}TaₓNb0.3B20, with x=12 . . . 20 at % a milling time of 13 hours is necessary to obtain similar dimensions. In the case of Fe_{79.7-x}MnₓNb_{0.3}B₂₀, where x=12-20 at. %, the milling time was 26 h, and the average powder dimensions range between 40 . . . 100 nm, depending on the Mn content. The powders obtained in this way are washed at least 5 times with heptane to remove the traces of oleic acid in ultrasound bath, each washing operation lasting at least 5 minutes. For their use in hyperthermia, the powders are additionally washed in a solution of NaOH 10% in ultrasound bath for at least 5 minutes, the operation being repeated 5 times. Powders are then dried for 2 h in a vacuum oven at 70° C. The tests for plotting the variation in time of the temperature of thermal equilibrium presented in FIG. 7 were carried out in an experimental set-up especially designed for hyperthermia, in the presence of an alternative magnetic field with H=350 mT and the frequency f=153 kHz. An amount of 10 mg powder is introduced in a double-walled glass vessel voided inside for a better thermal isolation, with a volume V=0.13 ml of H₂O, the mixture being induction heated by means of a high frequency generator. By controlling the Ti, Ta or Mn content, one can obtain equilibrium temperatures useful for hyperthermia (between 40° C. and 47-48° C.), like in FIG. 7(c), which is maintained irrespective of the heat duration and the value of the induction coil heating power. In this way one can realize, according to the invention, the self-control of the heating temperature in the case of hyperthermia, according to the necessities of the cancer cells destruction process.

### REFERENCES

[1] R. M. Bozorth, Ferromagnetism, Wiley-IEEE Press, 1993.
[2] T. Kaneyoshi, Introduction to Amorphous Magnets, World Scientific Publishing, 1992.
[3] V. Zhukova, S. Kaloshkin, A. Zhukov, J. Gonzalez, Journal of Magnetism and Magnetic Materials 249(1-2) (2002) p. 108-112.
[4] V. Zhukova, J. M. Blanco, M. I patov, A. Zhukov, C. Garcia, J. Gonzalez, R. Varga, A. Torcunov, Sensors and Actuators B 126 (2007) p. 318-323.
[5] J. Stergar, G. Ferk, I. Ban, M. Drofenik, A. Hamler, M. Jagodi\check{c}“, D. Makovec, Journal of Alloys and Compounds 576 (2013) P. 220-226.
[6] D. S. Choi, J. Park, S. Kim, D. H. Gracias, M. K. Cho, Y. K. Kim, A. Fung, S. E. Lee, Y. Chen, S. Khanal, S. Baral, J.-H. Kim, Journal of Nanoscience and Nanotechnology 8(5) (2008), p 2323-2327.
[7] N. Lupu, H. Chiriac, S. Corodeanu, G. Ababei, IEEE Transactions on Magnetics 47(10) (2011) p. 3791-3794.

1. Fe—Nb—B-based metallic magnetic material for use in magnetic sensors based on magnetic permeability variation and for hyperthermia applications, having 59-67 at. % Fe, between 0.1 and 1 at. % Nb and 20 at. % B, wherein it also contains biocompatible material chosen between Ti, Ta or Mn, in proportion of 12-20 at. %, with “glassy” quasi-amorphous structure, obtained under the form of ribbons, micro/nanowires and micro/nanopowders, the ratio of the biocompatible material being chosen such that the magnetic transition temperatures Tc ranges between 0 and 70° C., the saturation magnetic induction is between 0.05 and 1.1 T and the relative magnetic permeability is 3500-4000, and presenting a significant variation of over 90% of the magnetic permeability/susceptibility in the proximity of the magnetic transition temperature.

2. Process to obtain Fe—Nb—B-based metallic magnetic material with biocompatible elements, according to claim 1, under the form of metallic ribbons with thickness of 10-40 μm, width of 0.2-5 mm and specific quasi-amorphous “glassy” structure, comprising:
a first step of obtaining a metallic alloy from pure components within a vacuum chamber,
a second step of extracting pieces of 3-4 g each, from the metallic alloy, to provide a good homogeneity and an adequate shape to be taken up in an amorphizing crucible
a third step of introducing the pieces extracted in the second step in the amorphizing crucible ended with a piece of boron nitride, which has at its end a rectangular nozzle with the width of 0.5-0.8 mm and the length of 1-3 mm, depending on the wanted size of the ribbon to be produced, which is placed inside an induction coil consisting of 5 turns of copper pipe, supplied by a medium frequency power generator, in a high vacuum of minimum 104 mbar or in He or Ar atmosphere, through the application of an Ar overpressure of 0.15-0.22 bars, and
a fourth step of ejecting the molten alloy on a copper disc with the diameter of 36 cm, rotating with a peripheral speed of 30-35 m/s, at a distance of 0.5 mm from the lower margin of the boron nitride nozzle, in order to provide a uniform flow of the melted alloy.

3. Process to obtain Fe—Nb—B-based metallic magnetic material with biocompatible elements, according to claim 1, under the form of glass-coated micro/nanowires with metallic core diameters of 80-950 nm and glass coating thickness of 5-6.5 μm, with specific quasi-amorphous “glassy” structure, comprising:
a first step of obtaining a metallic alloy from pure components within a vacuum chamber,
a second step of extracting pieces of 3-4 g each, from the metallic alloy, to provide a good homogeneity and an adequate shape to be taken up in a Duran glass pipe with the diameter of 12 mm and glass wall thickness of 1 mm,
a third step of heating to melting the alloy in the Duran glass pipe with the diameter of 12 mm and glass wall thickness of 1 mm, sealed at bottom and connected at its upper part to a vacuum system with a 60-70 mm H2O vacuum in the glass tube, placed inside an induction coil supplied by a medium frequency power generator, in order to produce glass softening, and
a fourth step of drawing the melted alloy with a controlled speed of 2500-3000 m/min. on a collecting bobbin, resulting in the production of a glass-coated metallic nano/microwire.

4. Process to obtain Fe—Nb—B-based metallic magnetic material with biocompatible elements under the form of nano/micropowders with dimensions comprised between 5 nm and 80-100 μm, comprising the obtaining of the ribbons according to claim 2, and further comprises:
a fifth step of treatment of the ribbons obtained by the process according to claim 2 in a vacuum of 10⁻⁵ mbar at temperatures of 300-400° C. to diminish their hardness,
a sixth step of mechanical milling the ribbons, resulting the fragmentation of treated ribbons in pieces of 3-5 mm each by introduction in two hardened stainless steel milling vials of a planetary ball mill together with the balls, in a mass ratio balls:material=50:1, the milling being performed in a liquid medium in which the oleic acid and heptane represent 15-20 vol. % and 2-5 vol. %, respectively, from the quantity of milled material, at a rotation speed of the milling vials of 550 rpm, with a two-way rotation, for 1-120 hours,
a seventh step of washing the powders at least 5 times with heptane in a ultrasound bath to remove the oleic acid traces and
an eight step of drying it in vacuum oven for 2 h at the temperature of 70° C., and the powders have the same quasi-amorphous structure as that existing in the ribbons obtained and specific magnetic properties.

5. Process to obtain Fe—Nb—B-based metallic magnetic material with biocompatible elements, according to claim 1, under the form of nanopowders with dimensions of 5-100 nm, through arc discharge in inert gas atmosphere, comprising:
a first step of obtaining a metallic alloy from pure components within a vacuum chamber,
a second step of extracting pieces of 3-4 g each, from the metallic alloy, to provide a good homogeneity and an adequate shape to be taken up in a wolfram crucible;
a third step of introducing the pieces extracted in the second step in the wolfram crucible which represents one electrode of the arc discharge, situated at a distance of 4-5 mm from the second electrode consisting of wolfram rod, both electrodes being placed into a stainless steel sealed with double walls cooled with a liquid at the temperature of minus 10
minus 15° C., in high vacuum of 2×10⁻⁴ mbar or ultra pure He,
a fourth step of applying a high frequency potential difference between the two electrodes initiates the plasma of the d.c. electric arc, with I_{discharge}=40-200 A at a potential difference U_{discharge}=20-40 v, which determines the alloy melting and bringing it in the state of vapors, followed by the vapor deposition and cooling under the form of nanoparticles on the inner wall of the arc discharge chamber,
a fifth step of gathering the nanoparticles in argon atmosphere to avoid fast oxidation in contact with the atmospheric oxygen.

6. Fe—Nb—B-based metallic magnetic material for use in magnetic sensors based on magnetic permeability variation and for hyperthermia applications, having 59-67 at. % Fe, between 0.1 and 1 at. % Nb and 20 at. % B, also containing biocompatible material chosen between Ti, Ta or Mn, in proportion of 12-20 at. %, with “glassy” quasi-amorphous structure, obtained under the form of ribbons, micro/nanowires and micro/nanopowders, the ratio of the biocompatible material being chosen such that the magnetic transition temperatures Tc ranges between 0 and 70° C., the saturation magnetic induction is between 0.05 and 1.1 T and the relative magnetic permeability is 3500-4000, and presenting a significant variation of over 90% of the magnetic permeability/susceptibility in the proximity of the magnetic transition temperature, 2. under the form of metallic ribbons with thickness of 10-40 μm, width of 0.2-5 mm and specific quasi-amorphous “glassy” structure, comprising:
a first step of obtaining a metallic alloy from pure components within a vacuum chamber,
a second step of extracting pieces of 3-4 g each, from the metallic alloy, to provide a good homogeneity and an adequate shape to be taken up in an amorphizing crucible
a third step of introducing the pieces extracted in the second step in the amorphizing crucible ended with a piece of boron nitride, which has at its end a rectangular nozzle with the width of 0.5-0.8 mm and the length of 1-3 mm, depending on the wanted size of the ribbon to be produced, which is placed inside an induction coil consisting of 5 turns of copper pipe, supplied by a medium frequency power generator, in a high vacuum of minimum 104 mbar or in He or Ar atmosphere, through the application of an Ar overpressure of 0.15-0.22 bars,
a fourth step of ejecting the molten alloy on a copper disc with the diameter of 36 cm, rotating with a peripheral speed of 30-35 m/s, at a distance of 0.5 mm from the lower margin of the boron nitride nozzle, in order to provide a uniform flow of the melted alloy;
and under the form of nano/micropowders with dimensions comprised between 5 nm and 80-100 μm, further comprising:
a fifth step of treatment of the ribbons obtained by the process according to claim 2 in a vacuum of 10⁻⁵ mbar at temperatures of 300-400° C. to diminish their hardness,
a sixth step of mechanical milling the ribbons, resulting the fragmentation of treated ribbons in pieces of 3-5 mm each by introduction in two hardened stainless steel milling vials of a planetary ball mill together with the balls, in a mass ratio balls :material=50:1, the milling being performed in a liquid medium in which the oleic acid and heptane represent 15-20 vol. % and 2-5 vol. %, respectively, from the quantity of milled material, at a rotation speed of the milling vials of 550 rpm, with a two-way rotation, for 1-120 hours,
a seventh step of washing the powders at least 5 times with heptane in a ultrasound bath to remove the oleic acid traces and
an eight step of drying it in vacuum oven for 2 h at the temperature of 70° C., and the powders have the same quasi-amorphous structure as that existing in the ribbons, and specific magnetic properties.

7. Process to obtain Fe—Nb—B-based metallic magnetic material with biocompatible elements according to claim 4, wherein the ribbons obtain the specific magnetic properties.
